(19) United States
(12) Patent Application Publication
(10) Pub. No.: US 2008/0127174 A1
(43) Pub. Date: May 29, 2008

(54) Systems and methods for transmitting and installing software on a gaming machine in a gaming network

(75) Inventor: Paul A. Johnson, Reno, NV (US)

Correspondence Address: BEYER WEAVER LLP, P.O. BOX 70250, OAKLAND, CA, 94612-0250, US

(73) Assignee: IGT, Reno, NV (US)

(21) Appl. No.: 11/586,302

(22) Filed: Oct. 25, 2006

(51) Int. Cl. G06F 9/445

(52) U.S. Cl. 717/174

(57) ABSTRACT

Novel gaming systems, machines, and methods are described for transmitting gaming software between a gaming server and a gaming machine. A gaming machine receives updated and new game object files and a linker directive file. From these two components, the gaming machine or other type of gaming device is able to generate an updated or new gaming module without any further data or assistance from a gaming server or any other component in a gaming network. From the gaming server, the gaming machine only receives the specific game object files and a linker directive file, often amounting to a few hundred kilobytes of data. The updated object files and the linker directive file are input to a linker program that resides permanently on the gaming machine. The linker outputs an updated gaming module that executes on the gaming machine thereby enabling a user to play the updated game or a new game in real time that the user had requested. Using the methods of the present invention, a large volume of gaming machines can be updated with gaming modules in a short time.

### BACKGROUND OF THE INVENTION

1. Field of the Invention

The present invention relates to electronic gaming machines and servers and to wagering game software. More specifically, it relates to methods of propagating and installing gaming software on gaming machines in a gaming network.

2. Description of the Related Art

Gaming software in the field of wagering games is becoming increasingly sophisticated and voluminous. For example, software needed for a self-contained game, sometimes referred to as a gaming module, can reach 500 megabytes in size and be created from thousands of source files. Furthermore, the number of different games available for play on a gaming machine is increasing as developers of wagering games attempt to meet player demand for various styles and themes of games. Consequently, there are hundreds of increasingly complex wagering games and it is becoming impracticable to store even a small portion (e.g., a family of related game themes) of these games on a gaming machine.

Presently, gaming software is not dynamically downloaded from a central server to a gaming machine in an efficient manner that enables selection and play of games. Nor is gaming software downloaded in a way that does not significantly increasing network traffic. This prevents a gaming machine operator from being able to offer a wide selection of different games on a machine and from efficiently maintaining software on machines.

Transmitting and installing gaming software requires significant network bandwidth and resources. An emerging server-based gaming paradigm can become inefficient and over-burdened with network traffic from constantly transmitting voluminous gaming software. Presently, an entire gaming software module representing a single game is transmitted over the network even if only a minor update is needed to a game. Often such updates or maintenance can be implemented by only having to modify a few files in the module. In other cases, games having a common theme may share a large majority of files and so only a few files need to be replaced in a gaming module for a new game (having a common theme) to be implemented.

Therefore, what is needed is an efficient way to transmit and install gaming software so that new or updated games are available on gaming machines in a gaming network in a timely manner and without increasing gaming network traffic.

### SUMMARY OF THE INVENTION

Novel gaming systems, machines, and methods are described for transmitting gaming application software between a gaming server and a gaming machine. In the present invention, a gaming machine receives only game object files (binary files) that have been updated or that are new and a linker directive file, instead of an entire gaming module containing all the code necessary for executing a specific game. From these two components—the updated/new object files and the linker directive file—the gaming machine or other type of gaming device is able to generate an updated or new gaming module without any further data or assistance from a gaming server or any other component in a gaming network. A gaming machine does not need to receive an entire updated or new gaming module, often a very large file (e.g., 500 Mb). The gaming machine only receives specific game object files and a linker directive file, often amounting to a few hundred kilobytes of data.

A gaming server and gaming machine utilizing the present invention store files and programs in a configuration different from conventional gaming servers and machines. A gaming server, or other gaming component, such as a gaming machine, performing as a server in a peer-to-peer network, receives updated or new (collectively referred to as “updated”) files and a linker directive file for a specific wagering game, from a development or manufacturing site where gaming applications are developed. The gaming server may also receive a linker map file. The gaming server has a library of game packages, each game package being associated with a specific game. The updated files and linker directive and map files are stored in the game package corresponding to the specific game. The gaming server does not execute a linker program. The server transmits only updated gaming object files and the linker directive file to a gaming machine via a gaming network rather than transmitting an entire updated gaming module, essentially a monolithic binary object file that consumes significant bandwidth in the gaming network.

Upon receiving the updated object files and the linker directive file, which can be sent very efficiently and quickly over a gaming network because of the relatively small size of these components, the gaming machine begins processing the updated object files. The updated files and the existing, unmodified object files already resident on the gaming machine are combined to form a complete set of binary object files for a single game. The complete set of object files and the linker directive file are inputs to a linker program that resides permanently on the gaming machine. The linker outputs an updated gaming module that executes on the gaming machine, thereby enabling a user to play the updated game or a new game in real time that the user had requested. Thus, updates can be made to existing games and new games that do not have gaming modules on the machine can be implemented without having to bring the machine down or require an amount of time that would be unacceptable to users in a gaming environment. In this embodiment, the linker is a generic linker that can execute on various game objects under the direction of a linker directive file. In another embodiment, a specialized or customized linker is transmitted from the gaming server to the machine along with the updated game objects. The customized linker has an internal linker directive that instructs the linker to execute only on certain object files. Once the game module is created, the customized linker can be deleted or stored. The linker map file created on the gaming machine, as a by-product of the linker, is deleted or can be used as updated game module verification data that is transmitted back to the gaming server.

One aspect of the present invention provides a process of installing software on a gaming machine. Before the software is transmitted to a gaming machine, a gaming server receives a plurality of new game object files and a new linker directive file. The files are delivered from a development platform to the gaming server via any appropriate means, such as via CD-ROM or over a private and secure computer network. The gaming server determines a subset of game object files from the plurality of object files. The subset of files contains files that will replace game object files on the gaming machines. This is done via conventional means such as comparing individual object file version numbers that are stored on the gaming server to determine which files have been updated. The subset of game object files and the new linker directive file (the same one installed on the gaming server) are transmitted to the gaming machine via a gaming network. The subset of game object files is merged with the existing game object files to create an updated set of files. The updated set and the linker directive file are input to a linker program that resides on the gaming machine. The linker outputs an updated gaming module.

In some embodiments the plurality of new game object files replaces a plurality of pre-existing game object files and the linker directive file replaces a pre-existing linker directive file on the gaming server. In other embodiments, the subset of game object files is merged with pre-existing game object files resident on the gaming machine. In yet other embodiments, the subset of game object files is created by comparing version numbers or identifiers between new game object files and existing game object files and by including a game object file in the subset if the identifiers or numbers are different.

In another aspect of the present invention, a gaming network is comprised of a gaming server and a gamine machine. The gaming server has a storage area or memory that stores one or more game packages, wherein a game package includes a complete set of game object files, a linker directive file, and at least one game object file revision history. The game package may also include a linker map file. The game packages are stored in an area referred to as a game package library on the gaming server. A gaming machine, connected to the server via a gaming network, has a storage area for storing another complete set of game object files (the same as the set of game object files in the game package on the server), a linker directive file, and a linker program. Upon execution of the linker, the gaming machine stores an updated gaming module and a linker map file for a specific game.

In some embodiments the game package on the gaming server also includes a gaming machine list and game object file version data, contained in the file revision history, and where each game object file has an associated game object file revision history. In another embodiment, the gaming network has a peer-to-peer configuration in which a gaming machine has a storage medium for storing game packages, sets of game object files, linker directive files and map files, as well as a linker program and an updated gaming module.

In yet another aspect of the invention, a method of installing updated gaming software on a gaming machine involves transmitting from a gaming server and receiving at a gaming machine a set of updated game object files and a linker program containing a specific linker directive file. The linker program executes on the gaming machine and accepts as input a complete set of game object files comprising a specific wagering game. The complete set of game object files includes the updated set of game object files received from the gaming server. The output of the linker is the updated gaming software, such as an updated gaming module. The specific linker directive file causes the linker program to execute only on the complete set of game object files comprising the specific wagering game.

In yet another aspect of the invention, a method of updating wagering game software on a gaming machine is described. A gaming machine receives a linker directive file and a set of wagering game object files from a gaming server. Upon receiving the files, the gaming machine executes a linker to generate updated wagering game software. In some embodiments, the set of wagering game object files is determined on the gaming server using a game object file revision history data set stored on the gaming server.

In another aspect of the invention, a gaming server having a network interface, a storage medium, and a logic device is described. The storage medium contains one or more game packages which, in turn, contain game object files, a linker directive file, a linker map file, and one or more game object file revision history data sets. The logic device is configured to receive the game object files and the linker directive file, determine a subset of game object files, and transmit to a gaming machine the linker directive file and the subset of game object files.

In another aspect of the invention, a gaming machine has a network interface, a storage medium, and a logic device. The storage medium contains a set of wagering game object files, a linker directive file, a linker map file, a linker program, and an updated wagering gaming module. The logic device is configured to execute a linker program, thereby creating an updated wagering gaming module.

Some embodiments of the present invention are computer-readable storage mediums, for example tangible computer program products such as CD-ROMs, that store computer code that can be executed on gaming servers, gaming machines, general-purpose computers, video gaming consoles, mobile gaming devices, and various other computer devices. The computer code contains instructions for executing the method aspects of the present invention described above for installing and updating gaming software on a gaming machine.

The present invention provides hardware (such as gaming machines, gaming servers, network devices and so on) that is configured to perform the methods of the invention, as well as software to control devices to perform these and other methods.

These and other features of the present invention will be presented in more detail in the following detailed description of the invention and the associated figures.

### BRIEF DESCRIPTION OF THE DRAWINGS

References are made to the accompanying drawings, which form a part of the description and in which are shown, by way of illustration, specific embodiments of the present invention:

FIG. 1A is a flow diagram of a process for creating a gaming module.

FIG. 1B is a block diagram showing components involved in creating a gaming module.

FIG. 2 is a block diagram of a development platform, a gaming server, a gaming machine, and of data transmitted between these domains in accordance with one embodiment of the present invention.

FIG. 3 is a diagram of a game package in accordance with one embodiment of the present invention.

FIG. 4 is a block diagram of a development platform, a gaming server, a gaming machine, and of data transmitted between these domains in accordance with an alternative embodiment of the present invention.

FIG. 5 is a flow diagram of a process of transmitting and installing gaming software on a gaming machine in accordance with one embodiment of the present invention.

FIG. 6 is a block diagram showing a gaming server and a gaming machine in accordance with an alternative embodiment of the present invention.

FIG. 7A illustrates one example of a network topology for implementing certain aspects of the present invention.

FIG. 7B is a block diagram illustrating a simplified network topology for implementing an arbiter in a gaming network of the present invention.

FIG. 8 shows one perspective of a gaming machine and its external components and features configurable to implement some aspects of the present invention.

FIG. 9 illustrates a gaming machine and a gaming network that can be configured to implement some aspects of the present invention.

FIG. 10 illustrates an example of a network device that may be configured for implementing some methods of the present invention.

### DETAILED DESCRIPTION OF THE INVENTION

Exemplary applications of systems and methods according to the present invention are described. These examples are provided solely to add context and aid in the understanding of the invention. Thus, it will be apparent to one skilled in the art that the present invention may be practiced without some or all of the specific details described herein. In other instances, well-known process steps, system components, and software and network concepts have not been described in detail in order to avoid unnecessarily obscuring the present invention. Other applications are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

For example, although the present invention is directed primarily to gaming software, electronic gaming machines, servers, and networks, it is worth noting that some of the systems and methods disclosed herein might be adaptable for use in other types of devices or environments, such that their use is not restricted exclusively to the gaming context. In fact, it will be readily appreciated that a wide variety of machines and devices can be used in conjunction with the inventive systems and methods disclosed herein. Such other devices can be specialized gaming devices that do not amount to actual gaming machines, for example, electronic gaming machines that act as servers in peer-to-peer networks and mobile gaming devices, as well as any other device that can be implemented with the inventive software and hardware architectures disclosed and detailed herein. Such other adaptations may become readily apparent upon review of the following detailed description. Although such other applications can be used with the inventive systems and methods disclosed herein, for purposes of clarity the discussion here shall focus on examples involving actual gaming machines and servers for purposes of clarity.

Methods and systems for dynamically transmitting and installing gaming software from a central gaming software repository to gaming machines are described in the various figures. These methods and systems also allow for the efficient management of gaming machine networks. The processes and systems described are illustrated in the context of gaming in which gaming software modules are downloaded from a central gaming server to electronic gaming machines, including hand-held and other mobile gaming devices, in a casino or other gaming area such as at hotels, stores, and airports. However, the techniques, networks, and systems of the present invention can be applied in other contexts that generally require the transmission of software from a central repository or server computer to a client computing device.

Using the wagering game and gaming network context to illustrate the present invention, the basic gaming-machine readable representation of a game that is installed executed and played on an electronic gaming machine, such as one from the Advanced Video Platform (“AVP”) class of machines manufactured by International Game Technology, Inc. (“IGT”) of Reno, Nev., is technically referred to as a binary image. For many games, the binary image is typically 500 Mb or larger in size. Binary images are written and tested on a development platform by game application developers through processes well known in the field of gaming applications. However, for the purposes of describing the present invention and for providing context, it is useful to first briefly outline the general process of creating of binary image.

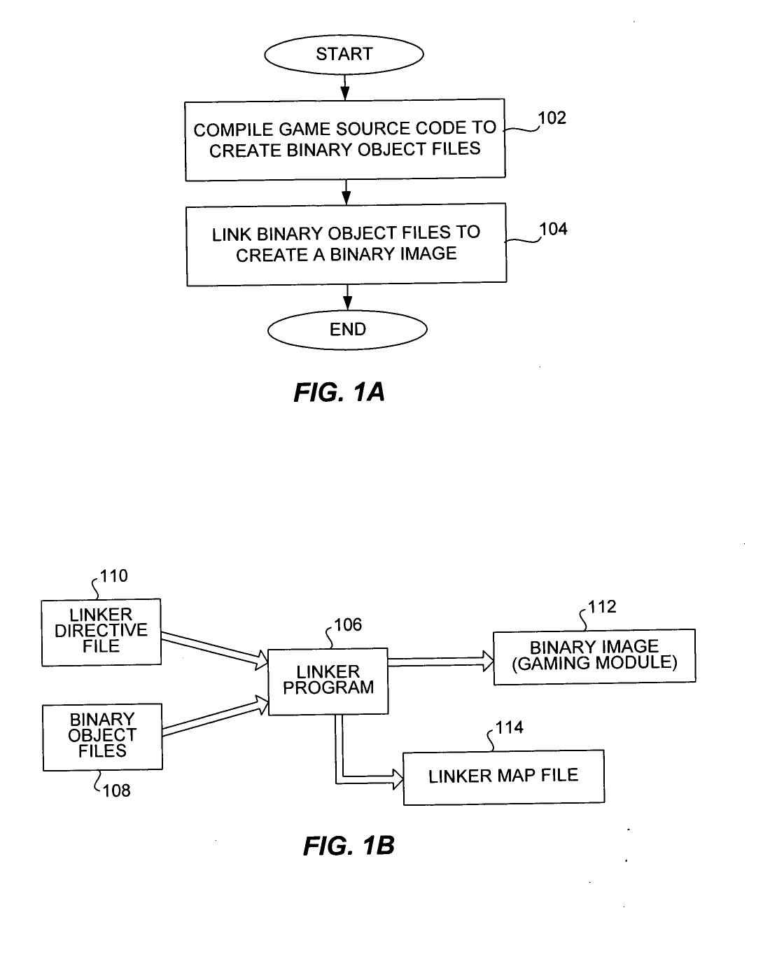

A game application is initially developed as a collection of source code files written by gaming application developers on a development platform. Typically there are anywhere from 500 to 6,000 or more source code files needed for a complete, self-contained gaming application. In the flow diagram of FIG. 1A, at step 102 source code files, for example, written in Java or C++, are compiled. The result of compiling a set of source code files is a corresponding set of binary object files containing binary code, each typically between 1 Kb to 1 Mb in size. At step 104, also performed on the development platform, the individual binary object files are linked to create a single binary image at which point the process of creating a binary image is complete. The binary image is a comparatively large contiguous block of binary code and comprises a gaming application or gaming module, and, as noted above, is about 500 Mb or larger and have become increasingly complex to take advantage of many recently developed hardware items and components have resulted in more advanced electronic gaming machines. As described in detail below, this monolithic block of code is eventually executed by processors on a gaming machine to play a game when invoked by a user.

Binary object files are linked by a linker program as shown in FIG. 1B. A linker (also referred to as a link editor) takes as input one or more binary object files, generated by a compiler and assembles the object files into a single executable program. The object files are program modules containing machine code and information for the linker. This information comes mainly in the form of symbol definitions. There are two types of symbols: defined/exported and undefined/imported symbols. The linker resolves references to undefined symbols by determining which other objects define a symbol in question, and replaces placeholders with the symbol's address. A linker program also arranges objects in a program's address space. This may involve relocating code that assumes a specific base address to another base. The executable output by the linker may need another relocation pass when it is loaded into memory, immediately prior to execution. Linkers can take objects from a library. Some linkers do not include an entire library in their output. Rather they only include its symbols that are references from other object files or libraries.

Inputs to a linker program 106 are individual binary object files 108 and a linker directive file 110. Linker directive file 110, which contains pre-defined directive functions that are often tailored to specific needs, controls the linker functions. Its primary functions are to dictate memory configuration, output section content, and allocation of output sections. The linking operation is controlled using linker directive file 110. Linker directives instruct the linker on creating the binary image. For example, directives can instruct linker program 106 which object files are to be included in the program, which library files are to be searched to resolve undefined references, and provides the name of the binary image. The primary output of linker program 106 is a binary image or gaming module 112. A by-product of linker 106 is a linker map file 114. Map file 114 provides data about the link that was executed. It includes data on where object files and symbols are mapped into memory, how common symbols are allocated, and provides information on all archive members included in the link.

Processes described in FIGS. 1A and 1B execute on a gaming development platform (not shown) at a software development center or “manufacturing site”. In a gaming network environment, the monolithic binary image or gaming module 112 that is created at step 104 is installed on a gaming server only after passing necessary regulatory approvals. In other scenarios, the gaming module is installed directly on a gaming machine, for example if the machine is a stand-alone machine, not connected to a network. Typically, a gaming server is at a casino or gaming area that is geographically separate from the software development center. Binary image 112 is installed on a gaming server using any appropriate and secure means such as via CD-ROM, transmission over a private network, such as a VPN tunnel, virtual local area network (VLAN), a portable disk drive or other portable storage medium, and so on.

Conventionally, once on a gaming server, the entire monolithic binary image or gaming module 112 is transmitted over a gaming network and installed or downloaded onto an electronic gaming machine and stored in non-volatile RAM. Only upon completion of the download, can the downloaded game be played.

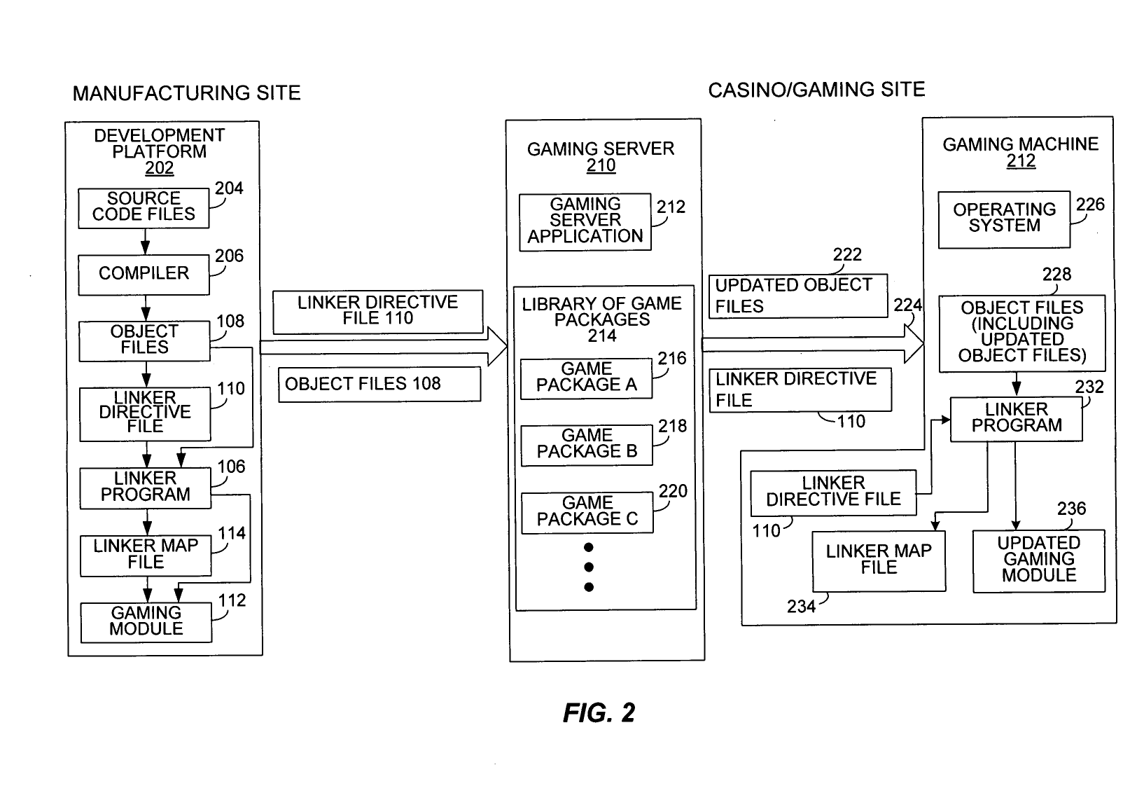

Methods, systems, and components of the present invention bypass the need to download an entire gaming module 112 to a gaming machine. FIG. 2 shows a development platform, a gaming server, a gaming machine, and data transmitted among these domains in accordance with one embodiment of the present invention. For purposes of illustrating the complete development cycle of a gaming module, FIG. 2 shows a development platform 202, typically implemented on an internal network with clients and server computers (not shown) at a manufacturing site where the gaming software is developed, quality tested, and prepared for production. As noted above, a single game originates in the form of numerous source code files 204 written in an appropriate programming language. Source code files 204 are input to a suitable compiler 206 which outputs binary object files 108. As shown in FIGS. 1A and 1B, object files 108 and linker directive file 110 are input to linker program 106. Output from linker 106 is gaming module 112 (i.e., the monolithic binary image) and a linker map file 114.

In a preferred embodiment, components from development platform 202 that are installed on gaming server 210 include object files 108 and linker directive file 110. In another preferred embodiment, linker map file 114 is also installed on gaming server 210. The installation can be performed using any appropriate means. In many cases the object files, map file, and directive file are stored on a CD-ROM and shipped to a casino operator who then installs it on gaming server 210. In other embodiments a secure network can be used, such as a VPN or VLAN utilizing encryption. Other “software as a service” (SaaS) techniques using public networks, such as the Internet, can be used to transmit these components to gaming server 210, typically at a gaming site such as a casino. In another preferred embodiment, gaming module 112 and verification data are also installed on the gaming server 210. However, these components are not needed for implementing the present invention.

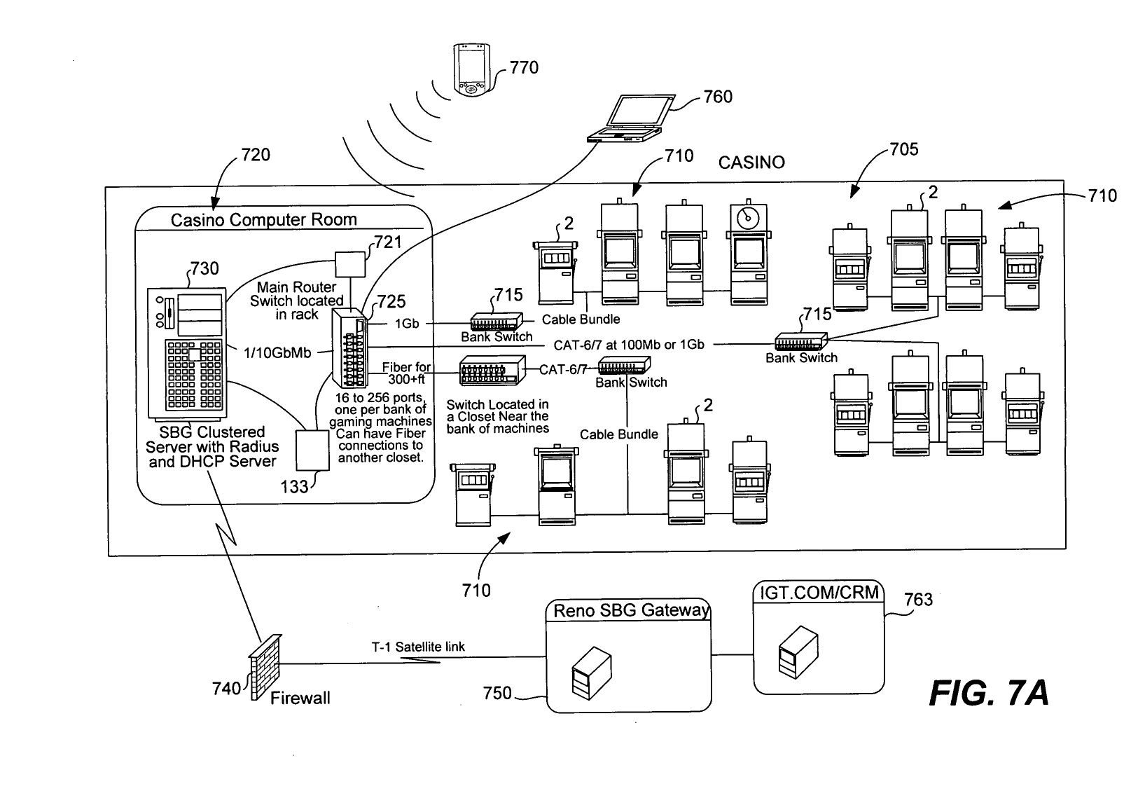

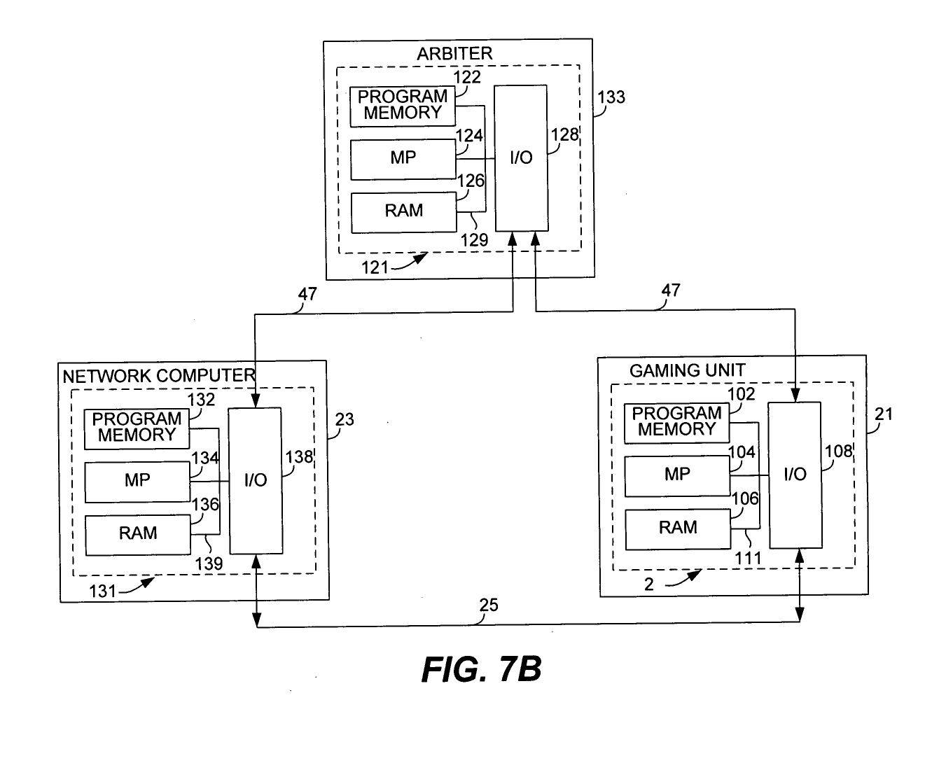

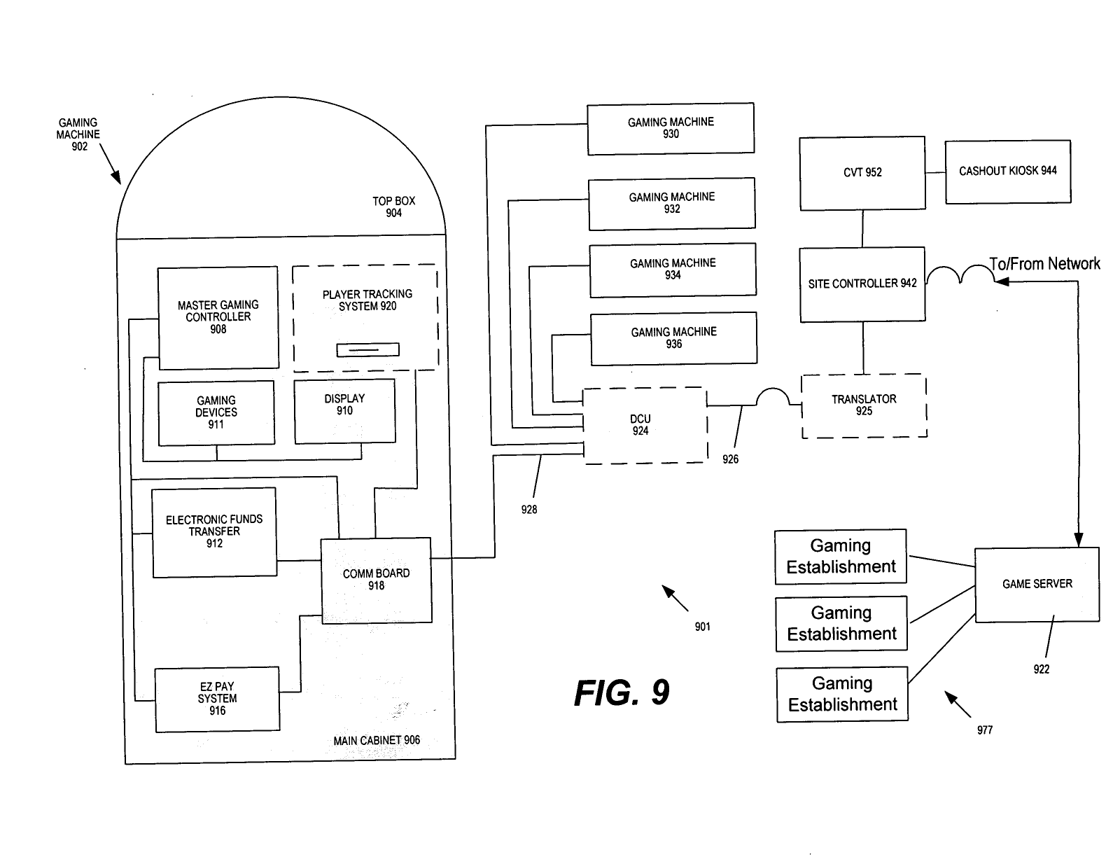

Gaming server 210 stores numerous software components. Among them are a gaming server application that maintains the overall operation and management of games on server 210 and is responsible for handling requests for games and game code transmission over a network of gaming machines described in detail in FIGS. 7A, 7B, and 9. Gaming server 210 has a library 214 of game packages. A game package, such as game package A 216, contains software and programs needed to create a gaming module for a particular game. A gaming server may have hundreds of game packages (game package B 218, game package C 220, and so on) in game package library 214.

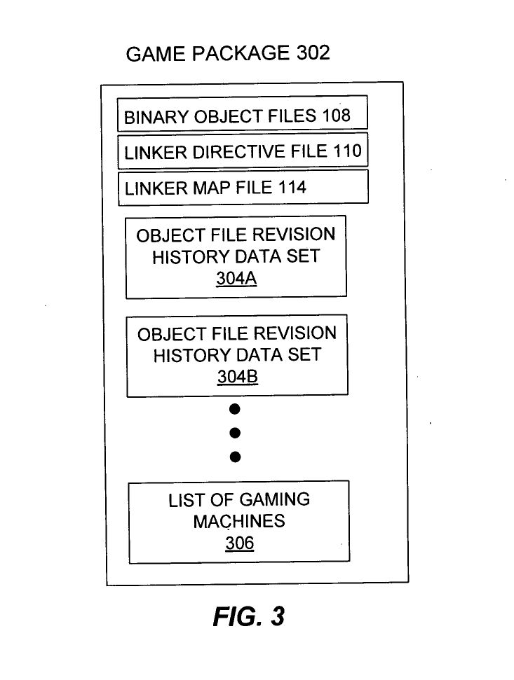

FIG. 3 is a diagram of a game package in accordance with one embodiment of the present invention. In a preferred embodiment, a game package 302 corresponds to one specific game and contains binary object files 108 and linker directive file 110. In another preferred embodiment, it also contains a linker map file 114.

In a preferred embodiment, a game package 302 contains data for a single game and has an object file revision history data set 304a, 304b, etc. for each gaming machine that contains the game corresponding to the game package. Thus, if there are 100 gaming machines that have the game, there are 100 revision history data sets in the game package. For example, if the game has 743 binary game object files, each data set has 743 entries, each entry comprising an object file name and version number. Each time object files are replaced in a game package, revision history data set 304a is checked for each gaming machine and a determination is made as to whether the object files on a gaming machine need to be updated. For example, if an game object file has been updated and is now version 4.3 and the revision history of a gaming machine shows that the machine has version 4.2, the gaming server will transmit the updated version 4.3 to the gaming machine.

In an alternative embodiment, a revision history data set for a specific gaming machine is stored on gaming machine 212. When gaming server 210 receives updated object files 108 for a particular game, gaming server 210 notifies each gaming machine that has the game that the binary files have been updated utilizing a gaming machine list 306. Upon being notified of the update, the gaming machines respond to server 210 with their revision histories. Server 210 checks to see which machines need updated binary object files 108 and transmits the updated binary game files to the machines. This embodiment requires more traffic over a gaming network and coordination between the gaming server and machines, but requires less memory on the gaming server which does not have to store revision history data sets for each gaming machine. This is advantageous in, for example a peer-to-peer network where a gaming machine acts as a gaming server.

Returning now to FIG. 2, only specific updated object files 222 and linker directive file 110 are transmitted to gaming machine 212 via network connection 224. Updated object files 222 and linker directive file 110 and other data described in embodiments below are transmitted over the network shown in FIGS. 7A and 7B. In a preferred embodiment, there are numerous components and modules on gaming machine 212. They include an operating system 226, all binary game object files 220, including the specific updated files 222, linker directive file 230, a linker program 232, a linker map file 234, and an updated, executable gaming module 236.

A gaming machine operating system 226 includes numerous software components and modules. Examples of gaming machine operating systems include Windows CE and QNX, but can be any other commercially available operating system software or any custom designed operating system, such as the customized operating system used by IGT for its 960i class of gaming machines. Software components can include, for example, boot and initialization routines, configured to call an initialization routine or other similar program from the firmware during a start up or boot process, credit and payout routines, image and audio generation programs, various component modules, a random number generator, diagnostics software, encryption and/or authenticator modules, among others. In general, a given operating system 226 tends to be the same or similar across numerous gaming machine titles within a gaming machine class, such as the 960i or AVP classes of gaming machines made by IGT. For example, all AVP gaming machines presently use the QNX operating system.

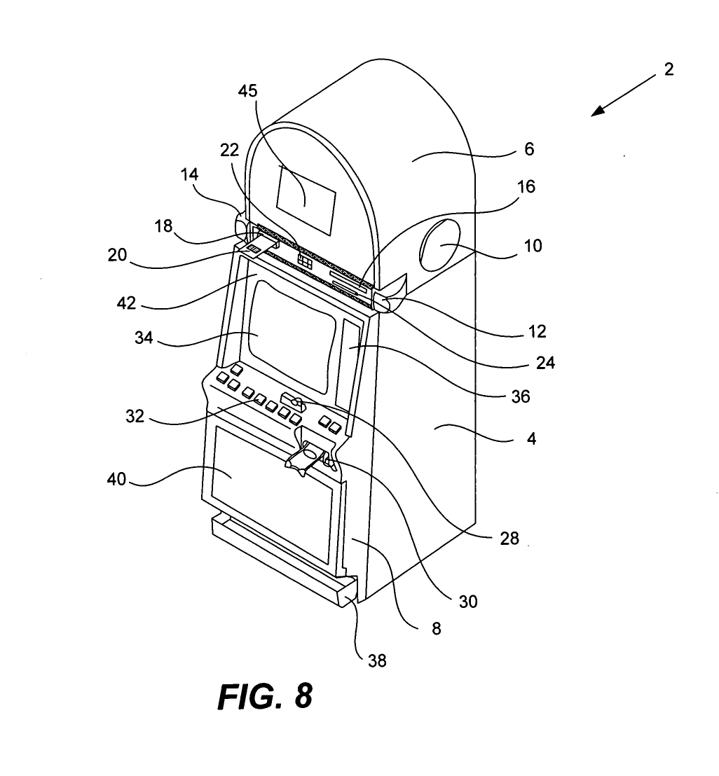

Operating system 226 generally combines with gaming module 236 to form what is known as a “gaming platform”. A gaming module 236 generally includes many or all of the software modules and routines outside of operating system 226 that are needed to execute a game with operating system 226 and given sets of firmware (not shown) and hardware on a gaming machine, as described in detail in FIG. 8. Firmware can include an initializer or other similar initialization routine or program, as well as additional modules such as a resource allocator and resource detector, among others.

Other software components on a gaming machine include various items such as a configurator, various managers, an application downloader, various gaming machine drivers, an authenticator, a diagnostics module, a graphics engine, a sound system, resource manager, game manager, bank manager, event manager, progressive manager, security guard, locale manager, system manager, presentation manager, tilt manager, system I/O controller, E2 driver, coin acceptor driver, bill validator driver, handle driver, hard meter driver, button panel driver, printer driver, hopper driver, light controller, EEPROM manager, and safe storage manager, among others.

On gamine machine 212, described in greater detail in FIG. 8 below, game object files 228, which now include the updated object files that were originally developed on development platform 202 and installed on gaming server 210 are input to a linker program 232 together with linker directive file 110, transmitted from gaming server 210. Linker program 232 permanently resides on gaming machine 212. The output from linker program 232 is the executable and updated gaming module 236 and a linker map file 234. Updated gaming module 236 is created on gaming machine 212 rather than being transmitted to the machine from gaming server 210 over a gaming network or installed via replacement of a hardware component, such as a memory chip or via CD-ROM.

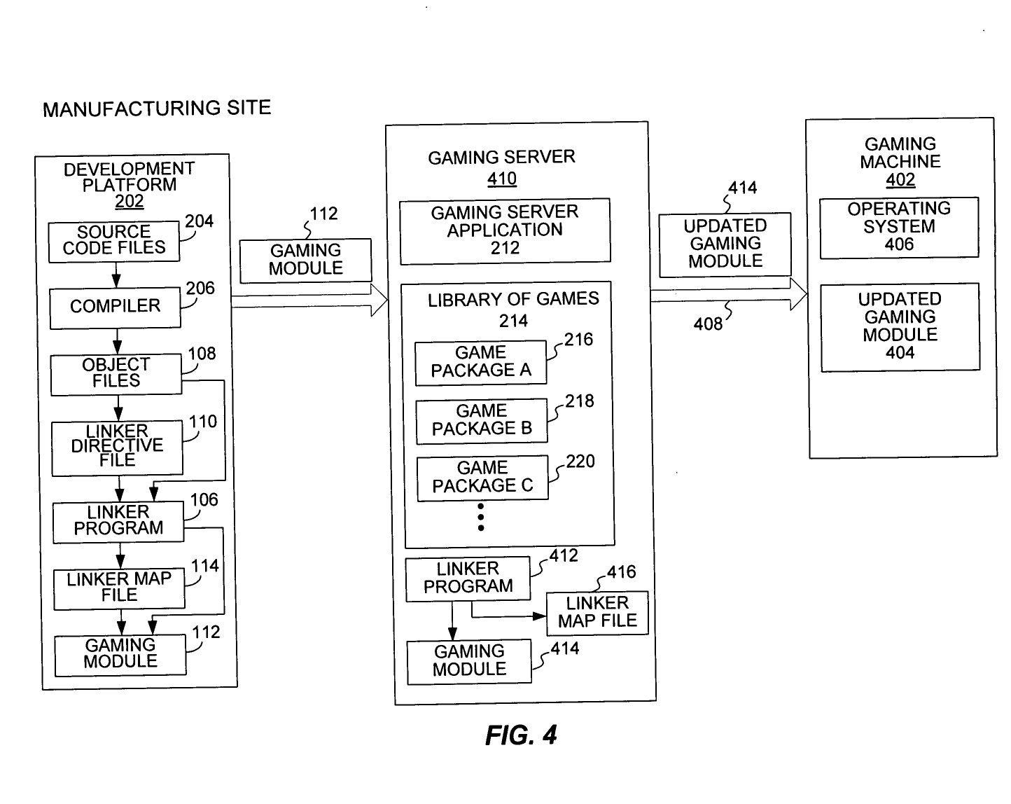

An alternative embodiment of the present invention is shown in FIG. 4. As first shown in FIG. 2, development platform 202 at a manufacturer's site has conventional components and modules, including: source code files 204, compiler 206, binary object files 108, linker directive file 110, and linker program 106. The output from linker program 106 includes gaming module 112 and linker map file 114. Gaming module 112 is installed on gaming server 410 via CD-ROM or other appropriate transmission and installation method. Gaming server 410 has a linker program 412. The inputs to linker 412 are the binary object files 108 stored in a game package such as game package A 216 (as shown in FIG. 3) and linker directive file 110. The output from linker program 412 are updated gaming module 414 and linker map file 416.

Updated gaming module 406 is transmitted over network connection 408 to gaming machine 402. Gaming machine 402 stores only a current gaming module 404 which is created from shared common binary object files and specific object files, and operating system 406. There are no other relevant gaming software components or modules. If updates are needed to gaming module 404, machine 402 is “brought down” or disabled and an updated gaming module 406 is downloaded to machine 402 via network connection 406. As an optional feature, game module verification data can be transmitted from gaming machine 402 to gaming server 410. In the alternative embodiment shown in FIG. 4, gaming server 410 allows for modularity and customability of game modules sent to gaming machine 402. It allows gaming modules to be created in an ad-hoc manner or on demand by the gaming machine. There are also reduced storage requirements on the gaming server 410.

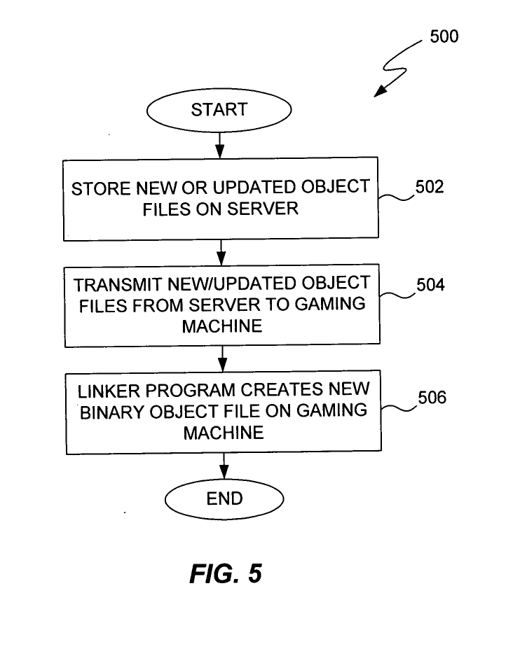

FIG. 5 is a flow diagram of a process 500 for enabling the transmission and installation of gaming software from a server to a gaming machine in accordance with one embodiment of the present invention. Steps of the methods shown and described herein need not be performed (and in some implementations are not performed) in the order indicated. Some implementations of these methods may include more or fewer steps than those described. As is known in the field of gaming application development, a gaming application is originally comprised of numerous source code files. When a game is updated, the source code files are updated and compiled on a development platform, creating updated object files. In a preferred embodiment of the present invention, at step 502 only the updated or new object files for the game are stored on a gaming server at a gaming site. As described above, many gaming modules have a base set of object files and a specific set of object files.

At step 504 the updated game object files only are transmitted from the server via a gaming network connection to a gaming machine. No other components or modules need to be transmitted from the gaming server to the machine. Given that the size of the updated object files is typically very small compared to entire gaming modules, the transmission of these data from a gaming server to a machine can be done efficiently and in sufficient time to enable real time game play of various games on a gaming machine. This also enables efficient maintenance of game software on a gaming machine wherein a gaming machine does not have to be “brought down” or disabled. Because updated object files can be transmitted very efficiently and updated gaming modules can be created on the gaming machine in nearly negligible time, the gaming machine is nearly always available for game play Thus, a user is able to select a game offered on a machine and the machine need only retrieve the specific object files for that game from the server. Similarly, when a game on a machine has been updated, the server only needs to send the updated game object files to the machine.

At step 506 a linker program on the gaming machine accepts as input the binary object files, which now include the updated object files for a specific game or update, and a linker directive file to create an updated gaming module and the process is complete.

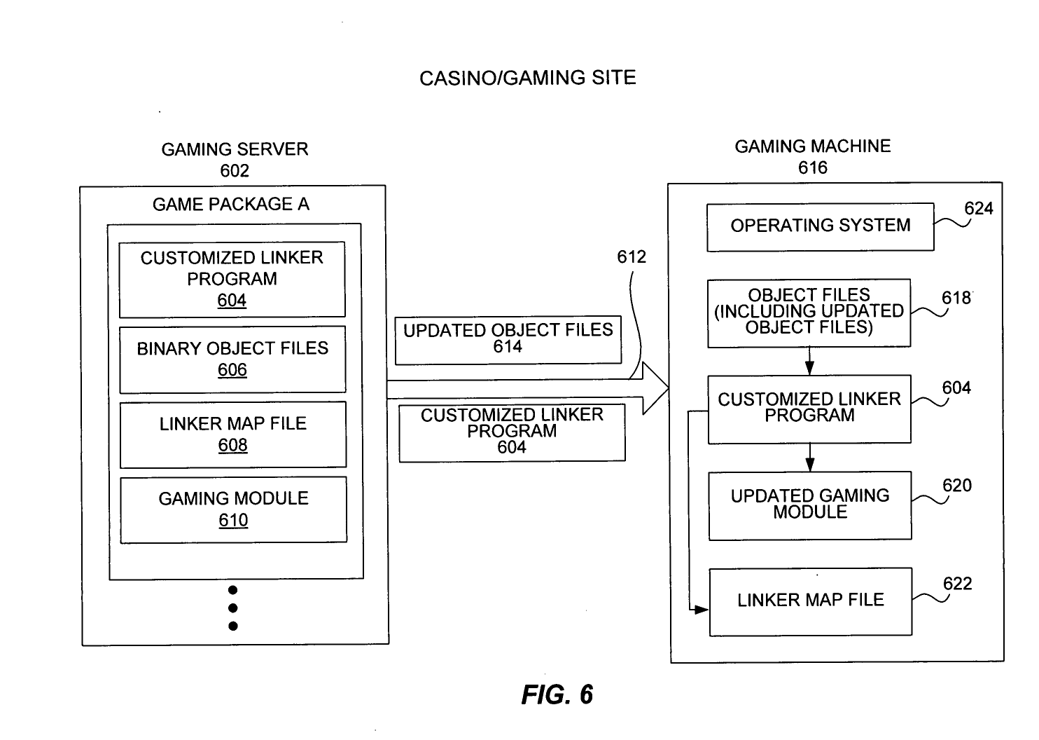

FIG. 6 is a block diagram showing an alternative embodiment of the present invention. Shown on a gaming server 602 is a game package A, which stores a customized linker program 604, binary object files 606, linker map file 608, and a gaming module 610. Binary object files 606 include updated game object files, which have been transmitted to and installed on gaming server 602. In this embodiment, a customized or specialized linker 604 has also been installed on server 602. As described with respect to FIG. 1B, a linker can be written to operate only on a specific set of binary object files. Normally, the instructions for a linker are contained in a linker directive file. In the described embodiment, the linker directive is programmed into linker program 604. Thus, linker 604 can only operate on a specific set of binary object files, that is, it will only search for and execute on pre-defined object files, and can only build a binary image using a particular order and methodology. The customization of linker 604 can be done at the software development site on the development platform.

Gaming server 602 transmits linker program 604 and the updated object files to a gaming machine 616 over a network connection 612. Once on gaming machine 616, customized linker 604 accepts as input binary game object files 618 which include the updated object files 614, as described in FIG. 2. Linker program 604 does not require a linker directive file as input. The output from linker program 604 is an updated gaming module 620 and a linker map file 622. Also resident on gaming machine 616 is operating system 624 similar to operating system 226. Thus, in this embodiment, specialized or customized linker program 604 is used to generate updated gaming modules on the gaming machine without the need for linker directive files. By having a customized linker, the linker can perform a certain type of verification while it creates the updated gaming module. For example, it could check object file revisions as it links them. It may also check CRCs on the object files ensuring that they have not been tampered with.

In addition, whether gaming software is requested via a user selecting a game or sent for maintenance and updates by a gaming operator, a preferred embodiment of the invention requires that the gaming machine or other recipient of gaming software be authenticated. In addition, gaming software may also be transferred in a manner that satisfies game licensing requirements and regulatory requirements of the gaming jurisdiction where the gaming machine is located. A secure gaming network notwithstanding, it is preferable to authenticate a requestor of a game download. For example, a software authorization agent may need to authenticate a requestor and approve access to game software transmissions before any downloading can take place. The approval process may be based not only upon the outcome of an authentication process but also upon an evaluation of pertinent licensing data, gaming regulatory requirements, and the like. In nearly all jurisdictions that regulate gaming activities, gaming module 236 is first approved by an appropriate regulatory agency or body and a signature of gaming module 236, such as a checksum, is computed. Methods and devices for authentication and game license management are described in U.S. patent application Ser. No. 11/225,408 (Attorney Docket No. IGT1P253), entitled “METHODS AND DEVICES FOR AUTHENTICATION AND LICENSING IN A GAMING NETWORK” by Kinsley et al., and is incorporated by reference herein in its entirety and for all purposes.

One example of a network topology, which includes network connections 224 and 408, for implementing some aspects of the present invention is shown in FIG. 7A. Those of skill in the art will realize that this exemplary architecture and the related functionality are examples and that the present invention encompasses many other such embodiments and methods.

In one embodiment, gaming modules and linker program data may be transferred between a gaming server and gaming machine or any two gaming devices using a satellite connection. A gaming machine using a satellite communication system, is connected to a satellite dish. For instance, a gaming machine located in a store or a cruise ship may use a satellite connection. Two standard coaxial cables may connect the gaming machine or device to the satellite dish. The gaming machine may include a satellite modem to enable the satellite connection.

A satellite dish may send requests to the Internet and receive Internet content via the satellite. The satellite, in turn, may communicate with a hub facility, which has a direct connection with the Internet. Typically, the transfer rate of information from a gaming device, such as gaming machine 212 or 402, to a satellite, referred to as the uplink rate, is less than the transfer of rate of information from a satellite to the gaming machine (downlink rate). For example, an uplink rate may be 28 kB per second while the downlink rate may be 500 kB per second or higher. However, for software downloads, a high downlink rate may only be required for efficient gaming module downloads. Satellite Internet services are commercially available, for example, from Starband Corporation of Mclean, Va.

In another embodiment, game object files and linker program data, as well as other gaming data are transferred between a gaming server and gaming machine using an radio frequency connection. As one example, US Telemetry Corporation of Dallas, Tex., uses radio frequency transmissions in the 218-222 MHz band to provide communications services to fixed end point devices as well as mobile devices. The fixed end point device may be a gaming machine located in a store or located in a casino, such as gaming machine 212 or 402, as well as a mobile gaming device such as a gaming machine located in a riverboat or portable gaming device that may be carried by a player and used to play a wagering game.

Returning to FIG. 7A, a single gaming establishment 705, in this case a casino, is illustrated. However, it should be understood that some implementations of the present invention involve multiple gaming establishments.

Gaming establishment 705 includes 16 gaming machines 2, each of which is part of a bank 710 of gaming machines 2. For example, gaming machine 2 includes gaming machines 212, 402, and 616. It will be appreciated that many gaming establishments include hundreds or even thousands of gaming machines 2, not all of which are included in a bank 710. However, the present invention may be implemented in gaming establishments having any number of gaming machines.

Various alternative network topologies can be used to implement different aspects of the invention and/or to accommodate varying numbers of networked devices. For example, gaming establishments with very large numbers of gaming machines 2 may require multiple instances of some network devices (e.g., of main network device 725, which combines switching and routing functionality in this example) and/or the inclusion of other network devices not shown in FIG. 7A. For example, some implementations of the invention may include one or more middleware servers disposed between gaming machines 2 and server 730, such as gaming server 210, 410, and 602. Such middleware servers can provide various useful functions, including but not limited to the filtering and/or aggregation of data received from bank switches 715, from individual gaming machines and from other player terminals. Some implementations of the invention include load balancing methods and devices for managing network traffic.

Each bank 710 has a corresponding bank switch 715, which may be a conventional bank switch. Each bank switch is connected to server-based gaming (“SBG”) server 730 via such as servers 210, 410, and 602 main network device 725, which combines switching and routing functionality in this example. Although various floor communication protocols may be used, some preferred implementations use an open, Ethernet-based SuperSAS® protocol developed by IGT and is available for downloading without charge. However, other protocols such as Best of Breed (“BOB”) may be used to implement various aspects of SBG. IGT has also developed a gaming-industry-specific transport layer called CASH that executes on top of TCP/IP and offers additional functionality and security.

SBG server 730, License Manager 721, Arbiter 133 and main network device 725 are disposed within computer room 720 of gaming establishment 705. License Manager 721 may be implemented, at least in part, via a server or a similar device. Some exemplary operations of License Manager 721 are described in detail in U.S. patent application Ser. No. 11/225,408 (Attorney Docket No. IGT1P253), entitled “METHODS AND DEVICES FOR AUTHENTICATION AND LICENSING IN A GAMING NETWORK” by Kinsley et al., which is hereby incorporated by reference.

SBG server 730 can be configured to implement, at least in part, various aspects of the present invention. Some preferred embodiments of SBG server 730 include (or are at least in communication with) clustered CPUs, redundant storage devices, including backup storage devices, switches, etc. Such storage devices may include a redundant array of inexpensive disks (“RAID”), back-up hard drives and/or tape drives, etc. Preferably, a Radius and a DHCP server are also configured for communication with the gaming network. Some implementations of the invention provide one or more of these servers in the form of blade servers.

In some implementations of the invention, many of these devices (including but not limited to License Manager 721 and main network device 725 are mounted in a single rack with SBG server 730. Accordingly, many or all such devices will sometimes be referenced in the aggregate as an “SBG server.” However, in alternative implementations, one or more of these devices is in communication with SBG server 730 but located elsewhere. For example, some of the devices could be mounted in separate racks within computer room 720 or located elsewhere on the network. For example, it can be advantageous to store large volumes of data elsewhere via a storage area network (“SAN”).

In some embodiments, SBG server 730 preferably has an uninterruptible power supply (“UPS”). The UPS may be, for example, a rack-mounted UPS module.

Computer room 720 may include one or more operator consoles or other host devices that are configured for communication with SBG server 730. Such host devices may be provided with software, hardware and/or firmware for implementing various aspects of the invention; many of these aspects involve controlling SBG server 730. However, such host devices need not be located within computer room 720. Wired host device 760 (which is a laptop computer in this example) and wireless host device (which is a PDA in this example) may be located elsewhere in gaming establishment 705 or at a remote location.

Arbiter 133 may be implemented, for example, via software that is running on a server or another networked device. Arbiter 133 serves as an intermediary between different devices on the network. Some implementations of Arbiter 133 are described in U.S. patent application Ser. No. 10/948,387, entitled “METHODS AND APPARATUS FOR NEGOTIATING COMMUNICATIONS WITHIN A GAMING NETWORK” and filed Sep. 23, 2004 (the “Arbiter Application”), which is incorporated herein by reference and for all purposes. In some preferred implementations, Arbiter 133 is a repository for the configuration information required for communication between devices on the gaming network (and, in some implementations, devices outside the gaming network). Although Arbiter 133 can be implemented in various ways, one exemplary implementation is discussed below.

FIG. 7B is a block diagram of a simplified communication topology between a gaming unit and machine 21, the network computer 23 and the Arbiter 133. Although only one gaming unit 21, one network computer 23 and one Arbiter 133 are shown in FIG. 7B, it should be understood that the following examples may be applicable to different types of network gaming devices within the gaming network 12 beyond the gaming unit 21 and the network computer 23, and may include different numbers of network computers, gaming security arbiters and gaming units. For example, a single Arbiter 133 may be used for secure communications among a plurality of network computers 23 and tens, hundreds or thousands of gaming units 21.

Referring to FIG. 7B, Arbiter 133 may include an arbiter controller 121 that may comprise a program memory 122, a microcontroller or microprocessor (MP) 124, a random-access memory (RAM) 126 and an input/output (I/O) circuit 128, all of which may be interconnected via an address/data bus 129. Network computer 23 may also include a controller 131 that may comprise a program memory 132, a microcontroller or microprocessor (MP) 134, a random-access memory (RAM) 136 and an input/output (I/O) circuit 138, all of which may be interconnected via an address/data bus 139. It should be appreciated that although the Arbiter 133 and the network computer 23 are each shown with only one microprocessor 124, 134, the controllers 121, 131 may each include multiple microprocessors 124, 134. Similarly, the memory of the controllers 121, 131 may include multiple RAMs 126, 136 and multiple program memories 122, 132. Although the I/O circuits 128 and 138 are each shown as a single block, it should be appreciated that the I/O circuits 128 and 138 may include a number of different types of I/O circuits. RAMs 124 and 134 and program memories 122 and 132 may be implemented as semiconductor memories, magnetically readable memories, and/or optically readable memories, for example.

Although the program memories 122, 132 are shown in FIG. 7B as read-only memories (ROM) 122, 132, the program memories of the controllers 121, 131 may be a read/write or alterable memory, such as a hard disk. In the event a hard disk is used as a program memory, the address/data buses 129, 139 shown schematically in FIG. 7B may each comprise multiple address/data buses, which may be of different types, and there may be an I/O circuit disposed between the address/data buses.

As shown in FIG. 7B, the gaming unit 21 may be operatively coupled to the network computer 23 via the data link 25. The gaming unit 21 may also be operatively coupled to the Arbiter 133 via the data link 47, and the network computer 23 may likewise be operatively coupled to the Arbiter 133 via the data link 47. Communications between the gaming unit 21 and the network computer 23 may involve different information types of varying levels of sensitivity resulting in varying levels of encryption techniques depending on the sensitivity of the information. For example, communications such as drink orders and statistical information may be considered less sensitive. A drink order or statistical information may remain encrypted, although with moderately secure encryption techniques, such as RC4, resulting in less processing power and less time for encryption. On the other hand, financial information (e.g., account information, winnings, etc.), game download information (e.g., game software and game licensing information) and personal information (e.g., social security number, personal preferences, etc.) may be encrypted with stronger encryption techniques such as DES or 3DES to provide increased security.

As disclosed in further detail in the Arbiter Application, Arbiter 133 may verify the authenticity of each network gaming device. Arbiter 133 may receive a request for a communication session from a network device. For ease of explanation, the requesting network device may be referred to as the client, and the requested network device may be referred to as the host. The client may be any device on the network 12 and the request may be for a communication session with any other network device. The client may specify the host, or the gaming security arbiter may select the host based on the request and based on information about the client and potential hosts. Arbiter 133 may provide encryption keys (session keys) for the communication session to the client via the secure communication channel. Either the host and/or the session key may be provided in response to the request, or may have been previously provided. The client may contact the host to initiate the communication session. The host may then contact Arbiter 133 to determine the authenticity of the client. Arbiter 133 may provide affirmation (or lack thereof) of the authenticity of the client to the host and provide a corresponding session key, in response to which the network devices may initiate the communication session directly with each other using the session keys to encrypt and decrypt messages.

Alternatively, upon receiving a request for a communication session, Arbiter 133 may contact the host regarding the request and provide corresponding session keys to both the client and the host. Arbiter 133 may then initiate either the client or the host to begin their communication session. In turn, the client and host may begin the communication session directly with each other using the session keys to encrypt and decrypt messages. An additional explanation of the communication request, communication response and key distribution is provided in the Arbiter Application.

Wireless devices are particularly useful for managing a gaming network. Such wireless devices could include, but are not limited to, laptops, PDAs or even cellular telephones. Referring once again to FIG. 7A, one or more network devices in gaming establishment 705 can be configured as wireless access points. For example, a casino manager may use a wireless handheld device to revise and/or schedule gaming machine configurations while roaming the casino floor. Similarly, a representative of a regulatory body could use a PDA to verify gaming machine configurations, generate reports, view activity logs, etc., while on the casino floor.

If a host device is located in a remote location, security methods and devices (such as firewalls, authentication and/or encryption) should be deployed in order to prevent the unauthorized access of the gaming network. Similarly, any other connection between gaming network 705 and the outside world should only be made with trusted devices via a secure link, e.g., via a virtual private network (“VPN”) tunnel. For example, the illustrated connection between SBG 730, gateway 750 and central system 763 (here, IGT.com) that may be used for game downloads, etc., is advantageously made via a VPN tunnel.

An Internet-based VPN uses the open, distributed infrastructure of the Internet to transmit data between sites. A VPN may emulate a private IP network over public or shared infrastructures. A VPN that supports only IP traffic is called an IP-VPN. VPNs provide advantages to both the service provider and its customers. For its customers, a VPN can extend the IP capabilities of a corporate site to remote offices and/or users with intranet, extranet, and dial-up services. This connectivity may be achieved at a lower cost to the gaming entity with savings in capital equipment, operations, and services.

There are many ways in which IP VPN services may be implemented, such as, for example, Virtual Leased Lines, Virtual Private Routed Networks, Virtual Private Dial Networks, Virtual Private LAN Segments, etc. Additionally VPNs may be implemented using a variety of protocols, such as, for example, IP Security (IPSec) Protocol, Layer 2 Tunneling Protocol, Multiprotocol Label Switching (MPLS) Protocol, etc. Details of these protocols, including RFC reports, may be obtained from the VPN Consortium, an industry trade group (http://www.vpnc.com, VPNC, Santa Cruz, Calif.).

For security purposes, any information transmitted to or from a gaming establishment over a public network may be encrypted. In one implementation, the information may be symmetrically encrypted using a symmetric encryption key, where the symmetric encryption key is asymmetrically encrypted using a private key. The public key may be obtained from a remote public key server. The encryption algorithm may reside in processor logic stored on the gaming machine. When a remote server receives a message containing the encrypted data, the symmetric encryption key is decrypted with a private key residing on the remote server and the symmetrically encrypted information sent from the gaming machine is decrypted using the symmetric encryption key. A different symmetric encryption key is used for each transaction where the key is randomly generated. Symmetric encryption and decryption is preferably applied to most information because symmetric encryption algorithms tend to be 100-10,000 faster than asymmetric encryption algorithms.

Providing a secure connection between the local devices of the SBG system and IGT's central system allows for the deployment of many advantageous features. For example, a customer (e.g., an employee of a gaming establishment) can log onto an account of central system 763 (in this example, IGT.com) to obtain the account information such as the customer's current and prior account status.

Moreover, such a secure connection may be used by the central system 763 to collect information regarding a customer's system. Such information includes, but is not limited to, error logs for use in diagnostics and troubleshooting. Some implementations of the invention allow a central system to collect other types of information, e.g., information about the usage of certain types of gaming software, revenue information regarding certain types of games and/or gaming machines, etc. Such information includes, but is not limited to, information regarding the revenue attributable to particular games at specific times of day, days of the week, etc. Such information may be obtained, at least in part, by reference to an accounting system of the gaming network(s), as described in U.S. patent application Ser. No. 11/225,407 (Attorney Docket No. IGT1P237/P-1051), by Wolf et al., entitled “METHODS AND DEVICES FOR MANAGING GAMING NETWORKS,” which has been incorporated herein by reference.

Automatic updates of a customer's SBG server may also be enabled. For example, central system 763 may notify a local SBG server regarding new products and/or product updates. For example, central system 763 may notify a local SBG server regarding updates of new gaming software, gaming software updates, peripheral updates, the status of current gaming software licenses, etc. In some implementations of the invention, central system 763 may notify a local SBG server (or another device associated with a gaming establishment) that an additional theme-specific data set and/or updates for a previously-downloaded global payout set are available. Alternatively, such updates could be automatically provided to the local SBG server and downloaded to networked gaming machines.

After the local SBG server receives this information, it can identify relevant products of interest. For example, the local SBG server may identify gaming software that is currently in use (or at least licensed) by the relevant gaming entity and send a notification to one or more host devices, e.g., via e-mail. A customer may choose to renew a gaming software license via a secure connection with central system 763 in response to such a notification.

Secure communication links allow notifications to be sent securely from a local SBG server to host devices outside of a gaming establishment. For example, a local SBG server can be configured to transmit automatically generated email reports, text messages, etc., based on predetermined events that will sometimes be referred to herein as “triggers.” Such triggers can include, but are not limited to, the condition of a gaming machine door being open, cash box full, machine not responding, verification failure, etc.

In addition, providing secure connections between different gaming establishments can enable alternative implementations of the invention. For example, a number of gaming establishments, each with a relatively small number of gaming machines, may be owned and/or controlled by the same entity. In such situations, having secure communications between gaming establishments makes it possible for a gaming entity to use a single SBG server as an interface between central system 763 and the gaming establishments.

In FIG. 8, an electronic gaming machine 2 is shown. Machine 2, which describes gaming machine 202, 402, and 616 (and shown also in FIGS. 7A and 7B) includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The display monitor 34 will typically be a cathode ray tube, high resolution flat-panel LCD, or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

As described above, many different types of games, including mechanical slot games, video slot games, video poker, video black jack, video pachinko and lottery, may be provided with gaming machines of this invention. In particular, the gaming machine 2 may be operable to provide play of many different instances of wagering games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The gaming machine 2 includes a top box 6, which sits on top of the main cabinet 4. The top box 6 houses a number of devices, which may be used to add features to a game being played on the gaming machine 2, including speakers 10, 12, 9, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in FIG. 8. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g., a master gaming controller) housed within the main cabinet 4 of the machine 2.

Gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines of the present assignee are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, it may appear that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As is well known in the field, PCs are generally not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware, software, and firmware components and architectures are utilized in gaming machines that are not typically found in general purpose computing devices, such as PCs. These components and architectures, as described below in more detail, include but are not limited to watchdog timers, voltage monitoring systems, state-based software architecture and supporting hardware, specialized communication interfaces, security monitoring and trusted memory.

A watchdog timer is normally used in IGT gaming machines to provide a software failure detection mechanism. In a normal gaming machine operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

In a preferred embodiment, gaming machines, or gaming platforms generally, computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage monitoring circuitry, these types of circuits only report voltage status to the operating software. Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition is generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

A preferred method of operation for gaming machine game software of present invention is to use a state machine. Different functions of a game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, a gaming machine does not advance from a first state to a second state until critical information that allows the first state to be reconstructed is stored. This feature allows the game to recover operation to the current state of play in the event of a malfunction, loss of power, etc that occurred just prior to the malfunction. After the state of the gaming machine is restored during the play of a game of chance, game play may resume and the game may be completed in a manner that is no different than if the malfunction had not occurred. Typically, battery-backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the time just prior to the malfunction, including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, IGT's Netplex is a proprietary communication protocol used for serial communication between gaming devices. As another example, SAS is a communication protocol used to transmit information, such as metering information, from a gaming machine to a remote device. Often SAS is used in conjunction with a player tracking system.

The gaming machines of the present invention may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine of the present invention by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in the gaming machine to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 from U.S. patent application Ser. No. 09/925,098, filed Aug. 8, 2001 and titled “PROCESS VERIFICATION,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming machines that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 8, when a user wishes to play gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter player tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions that affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 9. Visual effects include flashing lights, strobing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

An alternative gaming network that may be used to implement additional methods in accordance with other embodiments of the present invention is depicted in FIG. 9. Gaming establishment 901 could be any sort of gaming establishment, such as a casino, a card room, an airport, a store, etc. In this example, gaming network 977 includes more than one gaming establishment, all of which are networked to game server 922.

Here, gaming machine 902, and the other gaming machines 930, 932, 934, and 936, include a main cabinet 906 and a top box 904. The main cabinet 906 houses the main gaming elements and can also house peripheral systems, such as those that utilize dedicated gaming networks. The top box 904 may also be used to house these peripheral systems.

The master gaming controller 908 controls the game play on the gaming machine 902 according to instructions and/or game data from game server 922 or stored within gaming machine 902 and receives or sends data to various input/output devices 911 on the gaming machine 902. In one embodiment, master gaming controller 908 includes processor(s) and other apparatus of the gaming machine systems described above in FIGS. 2, 4, and 6. The master gaming controller 908 may also communicate with a display 910.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 908 may also communicate with EFT system 912, EZPay™ system 916 (a proprietary cashless ticketing system of the present assignee), and player tracking system 920. The systems of the gaming machine 902 communicate the data onto the network 922 via a communication board 918.

In another embodiment, gaming machines are in communication with one another in a peer-to-peer configuration over a suitable data network. Communication links can be established as shown between one gaming machine and one or more of the other gaming machines.

One or more of the gaming machines are configured to operate the same as game server, rather than coupling a separate gaming server to the network. Those skilled in the art will appreciate that the software, hardware or combination thereof within one or more of the gaming machines, described in greater detail below.

Gaming server or servers of the present invention can be effectively removed from the system while maintaining the same functionality. In one example, gaming modules are distributed among the various gaming machines. If possible, certain modules are installed on the particular gaming machines where users will likely request those games. When a user requests a particular game on a given machine, and that game is not already stored in memory on or accessible by the gaming machine it sends a request message to other gaming machines in the network.

It will be appreciated by those of skill in the art that embodiments of the present invention could be implemented on a network with more or fewer elements than are depicted in FIG. 8. For example, player tracking system 920 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Moreover, player tracking information may be combined with other information that is now readily obtainable by an SBG system.

Moreover, DCU 924 and translator 925 are not required for all gaming establishments 901. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, in the gaming industry, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 942 provides this function for gaming establishment 901. Site controller 942 is connected to a central system and/or other gaming establishments via one or more networks, which may be public or private networks. Among other things, site controller 942 communicates with game server 922 to obtain game data, such as ball drop data, bingo card data, etc.

In the present illustration, gaming machines 902, 930, 932, 934 and 936 are connected to a dedicated gaming network 922. In general, the DCU 924 functions as an intermediary between the different gaming machines on the network 922 and the site controller 942. In general, the DCU 924 receives data transmitted from the gaming machines and sends the data to the site controller 942 over a transmission path 926. In some instances, when the hardware interface used by the gaming machine is not compatible with site controller 942, a translator 925 may be used to convert serial data from the DCU 924 to a format accepted by site controller 942. The translator may provide this conversion service to a plurality of DCUs.

Further, in some dedicated gaming networks, the DCU 924 can receive data transmitted from site controller 942 for communication to the gaming machines on the gaming network. The received data may be, for example, communicated synchronously to the gaming machines on the gaming network.

Here, CVT 952 provides cashless and cashout gaming services to the gaming machines in gaming establishment 901. Broadly speaking, CVT 952 authorizes and validates cashless gaming machine instruments (also referred to herein as “tickets” or “vouchers”), including but not limited to tickets for causing a gaming machine to display a game result and cash-out tickets. Moreover, CVT 952 authorizes the exchange of a cashout ticket for cash. These processes will be described in detail below. In one example, when a player attempts to redeem a cash-out ticket for cash at cashout kiosk 944, cash out kiosk 944 reads validation data from the cashout ticket and transmits the validation data to CVT 952 for validation. The tickets may be printed by gaming machines, by cashout kiosk 944, by a stand-alone printer, by CVT 952, etc. Some gaming establishments will not have a cashout kiosk 944. Instead, a cashout ticket could be redeemed for cash by a cashier (e.g. of a convenience store), by a gaming machine or by a specially configured CVT.

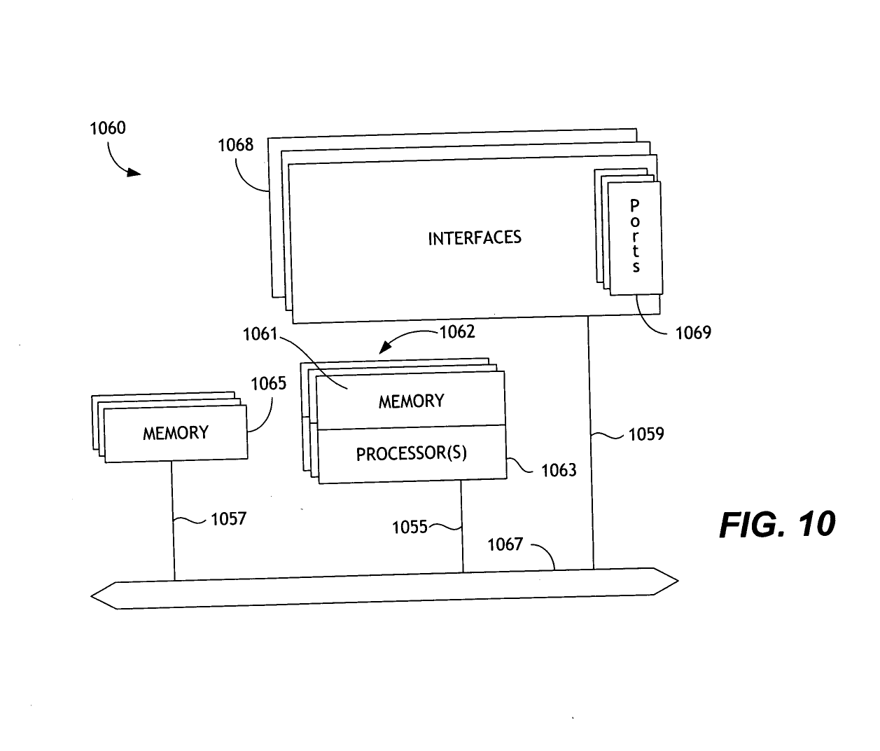

FIG. 10 illustrates an example of a network device that may be configured for implementing some methods of the present invention. Network device 1060 includes a master central processing unit (CPU) 1062, interfaces 1068, and a bus 1067 (e.g., a PCI bus). Generally, interfaces 1068 include ports 1069 appropriate for communication with the appropriate media. In some embodiments, one or more of interfaces 1068 includes at least one independent processor and, in some instances, volatile RAM. The independent processors may be, for example, ASICs or any other appropriate processors. Accordingly, these independent processors perform at least some of the functions of the logic described herein. In other embodiments, one or more of interfaces 1068 control such communications-intensive tasks as encryption, decryption, compression, decompression, packetization, media control and management. By providing separate processors for the communications-intensive tasks, interfaces 1068 allow the master microprocessor 1062 efficiently to perform other functions such as routing computations, network diagnostics, security functions, etc.

The interfaces 1068 are typically provided as interface cards (sometimes referred to as “linecards”). Generally, interfaces 1068 control the sending and receiving of data packets over the network and sometimes support other peripherals used with the network device 1060. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1062 may be responsible for implementing specific functions associated with the functions of a desired network device. According to some embodiments, CPU 1062 accomplishes all these functions under the control of software including an operating system and any appropriate applications software.

CPU 1062 may include one or more processors 1063 such as a processor from the Motorola family of microprocessors or the MIPS family of microprocessors. In an alternative embodiment, processor 1063 is specially designed hardware for controlling the operations of network device 1060. In a specific embodiment, a memory 1061 (such as non-volatile RAM and/or ROM) also forms part of CPU 1062. However, there are many different ways in which memory could be coupled to the system. Memory block 1061 may be used for a variety of purposes such as, for example, caching and/or storing data, programming instructions, etc.

Regardless of the network device's configuration, it may employ one or more memories or memory modules (such as, for example, memory block 1065) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 9 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 9) or switch fabric based (such as a cross-bar).

The above-described devices and materials will be familiar to those of skill in the computer hardware and software arts. Although many of the components and processes are described above in the singular for convenience, it will be appreciated by one of skill in the art that multiple components and repeated processes can also be used to practice the techniques of the present invention.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

I claim:

1. A method of installing software on a gaming machine, comprising:
receiving at a gaming server a plurality of new game object files and a new linker directive file;
determining at the gaming server a subset of game object files from the plurality of new game object files;
transmitting to the gaming machine the new linker directive file and the subset of game object files; and
executing on the gaming machine a resident linker program, thereby creating an updated gaming module.

2. The method of claim 1, further comprising executing a non-resident linker program wherein input to the non-resident linker program includes the plurality of new game object files and the new linker directive file.

3. The method of claim 2, wherein the non-resident linker program executes on a development platform.

4. The method of claim 3 wherein output from the non-resident linker program includes a non-resident updated game module and a new linker map file.

5. The method of claim 1, wherein the step of receiving further includes receiving a new, non-resident linker map file.

6. The method of claim 1, wherein the plurality of new game object files is comprised of new game object files and unaltered game object files.

7. The method of claim 1, wherein the plurality of new game object files and the linker directive file are for a single game.

8. The method of claim 1, further comprising replacing a first plurality of pre-existing game object files with the plurality of new game object files.

9. The method of claim 1, further comprising replacing a pre-existing linker directive file with the new linker directive file.

10. The method of claim 5, further comprising replacing a pre-existing linker map file with the new, non-resident linker map file.

11. The method of claim 1, further comprising merging the subset of game object files with a second plurality of pre-existing game object files resident on the gaming machine.

12. The method of claim 1, wherein the resident linker program outputs a new, resident linker map file.

13. The method of claim 1, wherein the step of determining a subset of game object files further includes comparing a first version identifier of a new game object file with a second version identifier of an existing game object file.

14. The method of claim 13, further comprising including the new game object file in the subset of game object files if the first version identifier is different from the second version identifier.

15. The method of claim 1 wherein the gaming machine is a mobile gaming device.

16. The method of claim 1 wherein the gaming server is a gaming machine in a peer-to-peer gaming network comprised of a plurality of gaming machines.

17. The method of claim 1 further comprising verifying with the gaming server that the updated gaming module was created correctly.

18. A gaming network comprising:
a gaming server having a first storage medium for storing at least one game package including a first set of game object files, a first linker directive file, a first linker map file, and at least one game object file revision history; and
a gaming machine having a second storage medium for storing a second set of game object files, a second linker directive file, a second linker map file, a linker program, and an updated gaming module.

19. The gaming network of claim 18, wherein the gaming server further comprises a gaming server application.

20. The gaming network of claim 18, wherein the game package further includes a gaming machine list.

21. The gaming network of claim 18, wherein the game object file revision history includes game object file version data.

22. The gaming network of claim 18, wherein the gaming machine further comprises an operating system.

23. The gaming network of claim 18, wherein for a game object file in the set of game object files, there is an associated game object file revision history.

24. The gaming network of claim 18, further comprising a development platform where the first linker map file is created.

25. The gaming network of claim 18, further comprising a development platform where the first linker directive file is created.

26. The gaming network of claim 18, wherein the gaming network is a peer-to-peer network and wherein a second gaming machine has a third storage medium for storing the game package and for storing the second set of game object files, the second linker directive file, the second linker map file, the linker program, and the updated gaming module.

27. The gaming network of claim 18, wherein the gaming machine is a mobile gaming device.

28. A method of installing updated gaming software on a gaming machine, comprising:
transmitting from a gaming server to a gaming machine an updated set of game object files;
transmitting from the gaming server to the gaming machine a linker program containing a specific linker directive file; and
executing the linker program on the gaming machine, wherein the only input to the linker program is a complete set of game object files comprising a specific wagering game, the complete set including the updated set of game object files and wherein an output of the linker program is the updated gaming software.

29. The method of claim 28, wherein a second output of the linker program outputs a linker map file.

30. The method of claim 29, further comprising utilizing the linker map file to verify the authenticity of the updated gaming software.

31. The method of claim 28, wherein the specific linker directive file causes the linker program to execute only on the complete set of game object files comprising a specific wagering game.

32. The method of claim 28, wherein the linker program is created for the specific wagering game at a development platform.

33. A method of updating wagering game software on a gaming machine, comprising:
receiving from a gaming server a linker directive file;
receiving from a gaming server a first set of wagering game object files; and
executing a linker on the gaming machine to generate updated wagering game software.

34. The method of claim 33, further comprising receiving at a gaming server the linker directive file.

35. The method of claim 33, further comprising receiving at a gaming server a second set of wagering game object files.

35. The method of claim 33, further comprising receiving at a gaming server a linker map file.

37. The method of claim 33, further comprising determining the first set of wagering game object files on the gaming server.

38. The method of claim 37, further comprising utilizing a wagering game object file revision history data set stored on the gaming server to determine the first set of wagering game object files.

39. The method of claim 33, wherein executing the linker further comprises inputting a complete set of wagering game object files to the linker, wherein the complete set of wagering game object files includes the first set of wagering game object files.

40. The method of claim 33, wherein executing the linker further comprises inputting the linker directive file to the linker.

41. The method of claim 33, wherein the linker is a customized linker that contains the linker directive file and only executes on a complete set of wagering game object files for a specific game, the complete set including the first set of wagering game object files.

42. The method of claim 33 further comprising verifying that the updated gaming software was created correctly.

43. A gaming server, comprising:
a network interface;
a storage medium for storing at least one game package including plurality of game object files, a linker directive file, a linker map file, and at least one game object file revision history; and
at least one logic device configured to perform the following:
receiving the plurality of game object files and the linker directive file;
determining a subset of game object files from the plurality of game object files; and
transmitting to a gaming machine the linker directive file and the subset of game object files.

44. A gaming machine, comprising:
a network interface;
a storage medium for storing a set of wagering game object files, a linker directive file, a linker map file, a linker program, and an updated wagering gaming module; and
at least one logic device configured to execute a linker program thereby creating the updated wagering gaming module.

45. A gaming system for installing software on a gaming machine, the system comprising:
means for receiving a plurality of new game object files and a new linker directive file at a gaming server;
means for determining a subset of game object files from the plurality of new game object files at the gaming server;
means for transmitting to the gaming machine the new linker directive file and the subset of game object files; and
means for executing on the gaming machine a resident linker program, thereby creating an updated gaming module.

46. The gaming system of claim 45, further comprising means for replacing a first plurality of pre-existing game object files with the plurality of new game object files.

47. The gaming system of claim 45, further comprising means for replacing a pre-existing linker directive file with the new linker directive file.

48. The gaming system of claim 45, further comprising means for merging the subset of game object files with a second plurality of pre-existing game object files resident on the gaming machine.

49. The gaming system of claim 45, further comprising means for including the new game object file in the subset of game object files if the first version identifier is different from the second version identifier.

50. A gaming system for installing updated gaming software on a gaming machine, the system comprising:
means for transmitting from a gaming server to a gaming machine an updated set of game object files;
means for transmitting from the gaming server to the gaming machine a linker program containing a specific linker directive file; and
means for executing the linker program on the gaming machine, wherein the only input to the linker program is a complete set of game object files comprising a specific wagering game, the complete set including the updated set of game object files and wherein an output of the linker program is the updated gaming software.

51. A gaming system for updating wagering game software on a gaming machine, the system comprising:
means for receiving a linker directive file from a gaming server;
means for receiving a first set of wagering game object files from a gaming server; and
means for executing a linker on the gaming machine to generate updated wagering game software.

52. The gaming system of claim 51, further comprising means for determining the first set of wagering game object files on the gaming server.

53. The gaming system of claim 52, further comprising means for utilizing a wagering game object file revision history data set stored on the gaming server to determine the first set of wagering game object files.

54. A computer-readable storage medium containing computer code for installing software on a gaming machine, the computer code comprising instructions for:
receiving at a gaming server a plurality of new game object files and a new linker directive file;
determining at the gaming server a subset of game object files from the plurality of new game object files;
transmitting to the gaming machine the new linker directive file and the subset of game object files; and
executing on the gaming machine a resident linker program, thereby creating an updated gaming module.

55. The computer-readable storage medium of claim 54, further comprising computer code for replacing a first plurality of pre-existing game object files with the plurality of new game object files.

56. The computer-readable storage medium of claim 54, further comprising computer code for replacing a pre-existing linker directive file with the new linker directive file.

57. The computer-readable storage medium of claim 54, further comprising computer code for merging the subset of game object files with a second plurality of pre-existing game object files resident on the gaming machine.

58. A computer-readable storage medium containing computer code for installing updated gaming software on a gaming machine, the computer code comprising instructions for:
transmitting from a gaming server to a gaming machine an updated set of game object files;
transmitting from the gaming server to the gaming machine a linker program containing a specific linker directive file; and
executing the linker program on the gaming machine, wherein the only input to the linker program is a complete set of game object files comprising a specific wagering game, the complete set including the updated set of game object files and wherein an output of the linker program is the updated gaming software.

59. A computer-readable storage medium containing computer code for updating wagering game software on a gaming machine, the computer code comprising instructions for:
receiving from a gaming server a linker directive file;
receiving from a gaming server a first set of wagering game object files; and
executing a linker on the gaming machine to generate updated wagering game software.

60. The computer-readable storage medium of claim 59, further comprising computer code for determining the first set of wagering game object files on the gaming server.

61. The computer-readable storage medium of claim 60, further comprising computer code for utilizing a wagering game object file revision history data set stored on the gaming server.
